(19) United States
(12) Patent Application Publication
(10) Pub. No.: US 2009/0323969 A1
(43) Pub. Date: Dec. 31, 2009

(54) COMMUNICATION METHOD, COMMUNICATION APPARATUS, AND INTEGRATED CIRCUIT

(75) Inventor: Ryuzou NISHI, Fukuoka (JP)

Correspondence Address: Dickinson Wright PLLC;James E. Ledbetter, Esq., International Square, 1875 Eye Street, N.W., Suite 1200, Washington, DC, 20006, US

(73) Assignee: MATSUSHITA ELECTRIC INDUSTRIAL CO., LTD., OSAKA (JP)

(21) Appl. No.: 12/130,566

(22) Filed: May 30, 2008

(30) Foreign Application Priority Data
May 31, 2007 (JP) 2007-144796
Apr. 28, 2008 (JP) 2008-116826

(51) Int. Cl. H04L 9/08

(52) U.S. Cl. 380/281; 380/44

(57) ABSTRACT

An object of the present invention is to realize a communication apparatus, a communication method, and an integrated circuit, capable of performing a key updating operation, while having resistibility with respect to noises and DoS attacks without increasing a frequency bandwidth. The present invention is such a communication apparatus for transmitting key update information via a transmission line to another communication apparatus, comprising: a key update information producing unit which generates the key update information having a first time width; a code information producing unit which generates code information which is employed so as to code the key update information; a time width expanding unit 20 for expanding the first time width to obtain a second time width; and a coding process unit 21 for performing a coding process with respect to key update information having the second time width by employing the code information.

### BACKGROUND

The present invention is related to a communication method, a communication apparatus, and an integrated circuit thereof, by which in a communication network, since all of communication terminals connected to the above-described communication network employ a shared encryption key, namely a group key, it is possible to avoid that such a communication terminal which is not connected to this communication network gives an adverse influence to communications of communication terminals connected to the communication network; and pairwise keys shared between communication terminals which actually perform communications are employed, the encryption key is updated in order to secure security of communications performed in the communication network.

As the ECHONET system shown in FIG. 13, for instance, the technical idea described in a non-patent publication (ECHONET SPECIFICATION Version 3.21, Second Unit, 10th section, ECHONET secure communication specification) is known.

Next, a description is made of the process flow for updating the group key in the ECHONET system.

Firstly, a control terminal 1000 generates a new group key (New Group Key). The new group key generated by a control terminal 1000 is encrypted based upon a previous group key (Pre Group Key), and then, the encrypted new group key is transmitted as an authentication request to a communication terminal 1001 (step S1000).

The communication terminal 1001 which has received the authentication request transmitted from the control terminal 1000 authenticates a new group key by employing the previous group key. When the authentication of the new group key can succeed, the communication terminal 1001 decodes the new group key based upon the previous group key so as to acquire a new group key (step S1001).

The communication terminal 1001 generates a response signal encrypted by using the previous group key, and then transmits the generated response signal to the control terminal 1000 (step S1002).

When the control terminal 1000 receives the response signal from the communication terminal 1001, the control terminal 1000 updates the group key employed within the communication network so as to obtain a new group key from the previous group key (step S1003). The communication terminal 1000 executes updating operation of the group key approximately one time per 1 hour.

As previously described, in the ECHONET system, a new group key is encrypted based upon a previous group key, and then, the encrypted group key is transmitted. In such a system, before a group key is updated within a communication network, a communication terminal which has once left from the communication network has already acquired such a group key (namely, previous group key) which is presently employed within the communication network. As a result, the above-described communication terminal is capable of acquiring a new group key when the group key is updated.

As a consequence, such a communication terminal which has once left from the communication network is capable of acquiring information which flows through the communication network without again receiving authentication from the control terminal 1001. As a result, if the communication terminal left from the communication network is used by a third party having a bad willing, then there are some possibilities that the information may be acquired in an illegal manner, and an illegal access to the communication network may occur.

As communication systems using group keys other than the above-described ECHONET system, wireless LAN (Local Area Network) systems may also be conceived. Under the IEEE 802.11i specification which determines the security standard of the wireless LAN, the protocol “4-way Handshake” has been defined as an update protocol of a group key. The contents of the above-described specification IEEE 802.11i are disclosed in a non-patent publication (IEEE Std 802.11i-2004).

In this protocol, the below-mentioned process is present: That is, such an information which is required in order to form an encryption key employed when a group key is distributed is shared between a master terminal and a slave terminal by a handshake which has not been encrypted.

In this case, if this information is analyzed, then the above-described encryption key can be calculated. As a result, there are such problems that the group key may be acquired by a third party in an illegal manner, and also, an illegal access to a communication network may occur.

Also, in such a case that a PMK (Pairwise Master Key) is generated from a passphrase which is manually inputted by a user, the above-described PMK is acquired by employing a dictionary attack, so that a PTK (Pairwise Transient Key) used in encryption during communication can be calculated.

As a consequence, also in wireless LANs, there are some possibilities that information transmitted on communication networks may be acquired in illegal manners, and illegal accesses to the communication networks may occur, which may cause security problems.

Also, in the ECHONET system and the IEEE 802.11i specification, communication terminals (slave terminals) issue responses with respect to all of key update requests.

As a consequence, since an attacker transmits a large amount of key update requests with respect to a communication terminal, the attacker can stop a key update handshake which is carried out between a control terminal and the communication terminal. This handshake stopping operation will also be referred to as a DoS attack (Denial-Of-Service).

Also, in order to perform an encryption communication after a group key has been updated, signals transmitted and received when the group key is updated must be transmitted without any error between a control terminal (master terminal) and a communication terminal (slave terminal).

If such a signal for updating a group key contains an error, which is received by the control terminal and/or the communication terminal, then the control terminal and/or the communication terminal are required to re-transmit this signal having the error, which may cause an occurrence of a transmission delay time.

In a highspeed power line communication, since a power line is employed as a transmission line, the highspeed power line communication may be readily and adversely influenced by noises which are generated from consumer electric appliances (for instance, hair dryer, recharging device etc.) connected to the power line. In other words, since the power line functions as a deteriorated transmission line, there are many possibilities that transmission errors may easily occur. A delay caused by erroneously transmitting a key update handshake may cause such a problem that transmission qualities may be lowered in such data transmissions which require delay compensations, for instance, image data distributions, IP (Internet Protocol) telephone, and so on.

Also, spread spectrum communication systems have been proposed as communication systems capable of improving resistibility with respect to noises and DoS attacks.

In FIG. 14A, a multiplying unit 301 multiplies transmission data by a spread code. The transmission data is transmitted to a communication terminal on the reception side as a product calculated between the own transmission data and the spread code. FIG. 14B indicates a process (de-spreading process) of a reception system in the spread spectrum communication system. When the communication terminal on the reception side receives reception data, namely, such a product calculated between the spread code and the transmission data in the communication terminal on the transmission side, a multiplying unit 4000 calculates a product between the reception data and the spread code, and then, outputs the calculated product. An integrating unit 4001 integrates the output signals from the multiplying unit 4000, and then outputs the calculation result. A judging unit 402 judges a polarity with respect to an output signal from the integrating unit 4001.

FIG. 15 represents transmission data “A” having a 1-bit information amount. Also, FIG. 15 shows a spread code having an “n”-bit information amount. A speed of the spread code is “n” times higher than a speed of the spread code. Further, FIG. 15 shows output data from a communication terminal on the transmission side. As apparent from the output data shown in FIG. 15, an information amount of the output data from the communication terminal on the transmission side may become “n” times larger than an information amount of the transmission data per unit time. In other words, a data rate of the output data from the communication terminal on the transmission side becomes “n” times higher than a data rate of the transmission data.

As can be understood from FIG. 16, when the spreading process is carried out, a frequency bandwidth of the transmission data is widened by “n” times. Such a widening phenomenon of the frequency bandwidth may occur, since the information amount of the transmission data is increased by “n” times due to the spreading process.

As apparent from the foregoing descriptions, in the spread spectrum communication system, the following fact can be understood that the amount of the information which is transmitted per unit time is increased, and the frequency bandwidth of the signal outputted from the communication terminal on the transmission side is increased in conjunction with the increase of the information amount.

In this connection, the below-mentioned technical idea is considered: That is, the spread spectrum communication system is applied to a power line communication. The frequency band which has been allowed to be used in the power line communication is 2 MHz to 30 MHz. Generally speaking, in power line communications, a substantially entire frequency band covered from 2 MHz up to 30 MHz is utilized so as to perform the power line communications in order to improve a transmission efficiency.

As a consequence, in order to improve the resistibility with respect to the noises and the DoS attacks, if the spread spectrum communication system is applied to the power line communication, then the below-mentioned problem may occur. For instance, if such a spread code having “n”=10 bits is applied to the transmission data, then such a wider frequency band covered from approximately 2 MHz up to approximately 282 MHz is necessarily required, which cannot be permitted in view of a legal aspect.

### SUMMARY

The below-mentioned embodiment of the present invention has been made to solve the above-described problems, and therefore, has an object thereof to realize a communication apparatus, a communication method, and an integrated circuit, capable of performing a key updating operation, while having resistibility with respect to noises and DoS attacks without increasing a frequency bandwidth.

A communication apparatus, according to the below-mentioned embodiment, is characterized by such a communication apparatus for transmitting key update information via a transmission line to another communication apparatus, comprising: a key update information generating section which generates the key update information having a first time width; a code information generating section which generates code information which is employed to code the key update information; a time width expanding section that expands the first time width to a second time width; and a coding process section that performs a coding process with respect to key update information having the second time width by employing the code information.

In accordance with the above-described communication apparatus, the time width of the key update information is expanded from the first time width up to the second time width, and the key update information having the second time width is coded. As a result, a transmission information amount per unit time as to the coded key update information is not increased, so that the key update information can be transmitted without broadening the frequency band.

An integrated circuit, according to the below-mentioned embodiment, is characterized by such an integrated circuit which is employed in a communication apparatus for transmitting key update information via a transmission line to another communication apparatus, comprising: a key update information generating section which generates the key update information having a first time width; a code information generating section which generates code information which is employed to code the key update information; a time width expanding section that expands the first time width to a second time width; and a coding process section that performs a coding process with respect to key update information having the second time width by employing the code information.

In accordance with the above-described integrated circuit, it is possible to realize such an integrated circuit: That is, the time width of the key update information is expanded from the first time width up to the second time width, and the key update information having the second time width is coded. As a result, a transmission information amount per unit time as to the coded key update information is not increased, so that the key update information can be transmitted without broadening the frequency band.

A communication method, according to the below-mentioned embodiment, is characterized by such a communication method for transmitting key update information via a transmission line to another communication, comprising: generating the key update information having a first time width; generating code information which is employed to code the key update information; expanding the first time width to a second time width; and performing a coding process with respect to key update information having the second time width by employing the code information.

In accordance with the above-described communication method, it is possible to realize such a communication method: That is, the time width of the key update information is expanded from the first time width up to the second time width, and the key update information having the second time width is coded. As a result, a transmission information amount per unit time as to the coded key update information is not increased, so that the key update information can be transmitted without broadening the frequency band.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a structural diagram of a power line communication system according to an embodiment of the present invention;

FIG. 2A is an outer appearance perspective view for representing a front plane of a PLC modem according to the embodiment;

FIG. 2B is a front view of the PLC modem according to the embodiment; and

FIG. 2C is a rear view of the PLC modem according to the embodiment;

FIG. 3 is a block diagram for indicating an arrangement of the PLC modem according to the embodiment;

FIG. 4 is a schematic functional block diagram for representing one example as to a digital signal processing unit realized by the PLC•IC according to the embodiment;

FIG. 5 is a diagram for showing a handshake when a group key is updated according to the embodiment;

FIG. 6 is a flow chart for describing an updating process of the group key according to the embodiment;

FIG. 7 is a flow chart for describing another updating process of the group key according to the embodiment;

FIG. 8 is a block diagram for indicating a circuit for performing the updating process of the group key according to the embodiment;

FIG. 9 is a diagram for indicating a coding process block for encrypting a key update message according to the embodiment;

FIG. 10 is a diagram for explaining a detailed content of the coding process represented in FIG. 9 according to the embodiment;

FIG. 11 is a diagram for indicating a coding process block for decoding a key update message according to the embodiment;

FIG. 12 is a diagram for explaining a detailed content of the coding process shown in FIG. 11 according to the embodiment;

FIG. 13 is a diagram for representing a process flow for updating the group key of the ECHONET system according to first prior art;

FIGS. 14A and 14B are diagrams for showing a block for executing the spreading/de-spreading process in the spread spectrum communication system according to second prior art;

FIG. 15 is a diagram for showing the timing chart of the spreading process according to the second prior art; and

FIG. 16 is a diagram for representing the transmission data before the spreading process is carried out, and the transmission data after the de-spreading process is carried out on the frequency axis according to the second prior art.

### DETAILED DESCRIPTION

### Embodiment

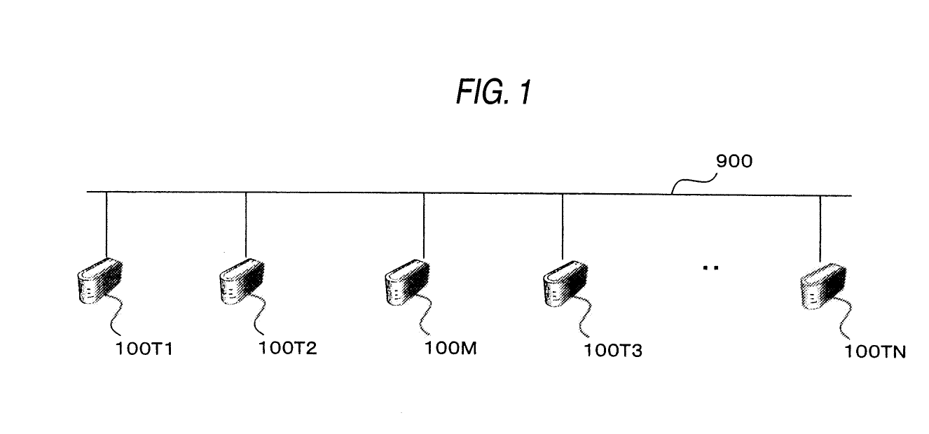

The power line communication system of FIG. 1 is provided with plural sets of PLC (Power Line Communication) modems 100M, 100T1, 100T2, 100T3, . . . , 100TN, which are connected to a power line 900. Although 5 sets of PLC modems 100M, 100T1, 100T2, 100T3, . . . , 100TN have been illustrated in FIG. 1, numbers as to PLC modems to be connected to the power line 900 may be arbitrarily selected. The PLC modem 100M functions as a master modem, and manages connection conditions (link conditions) of other PLC modems 100T1, . . . , 100TN, which function as slave modems.

In the below-mentioned explanations, when a description is made of both the master modem and a specific slave modem, these master modem and specific slave modem will be described as the PLC modems 100M, 100T1, 100T2, 100T3, . . . , 100TN; when a description is made of, generally speaking, a slave modem, this slave modem will be described as a PLC modem 100T; and also, when a description is made of such a PLC modem which is not limited only to a master modem and slave modems, this PLC modem will be simply described as a PLC modem 100.

Although the power line 900 has been indicated by employing 1 line in FIG. 1, the power line 900 is actually constructed by employing 2, or more pieces of conducting lines. The PLC modem 100 has been connected to 2 pieces of conducting lines within these plural conducting lines.

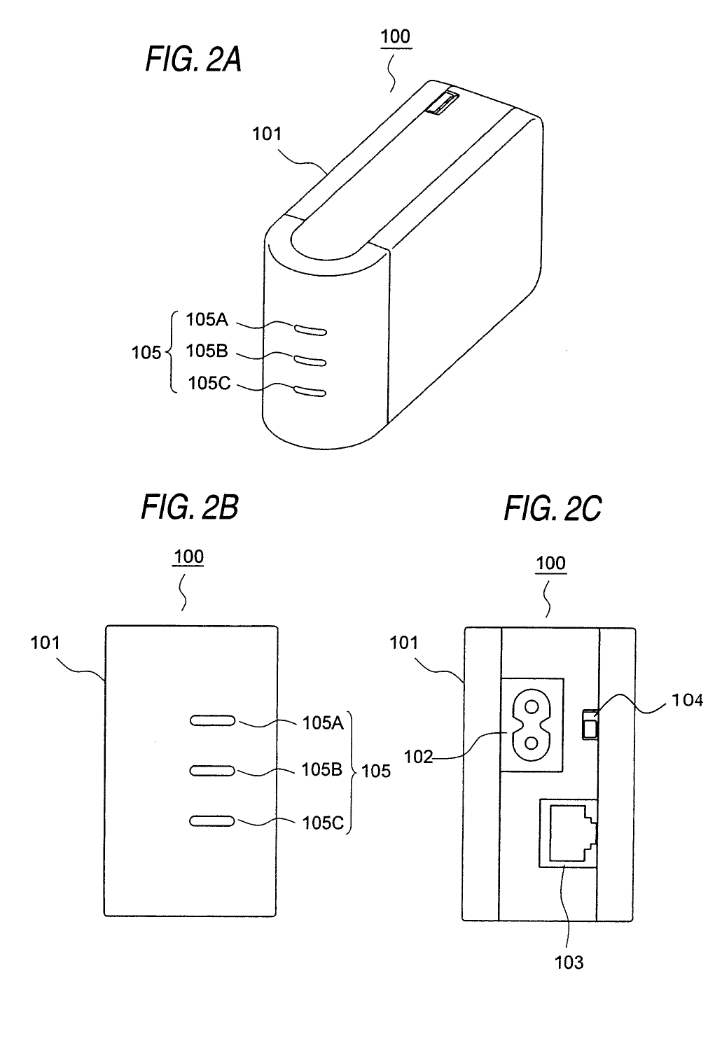

The PLC modem 100 shown in FIGS. 2A to 2C has a housing 101, and a display unit 105 is provided on a front plane of he housing 101. As indicated in FIG. 2A and FIG. 2B, the display unit 105 is constituted by LEDs (Light Emitting Diodes) 105A, 105B, and 105C. The display unit 105 displays thereon a communication speed of the PLC modem 100.

Also, as represented in FIG. 2C, a power supply connector 102, a LAN (Local Area Network)-purpose modular jack 103 such as RJ45, and a selecting switch 104 for selectively switching operation modes have been provided on a rear plane of the housing 101.

A power supply cable (which is not shown in FIG. 2) is connected to the power supply connector 102; and a LAN cable (which is not indicated in FIG. 2) is connected to the modular jack 103. It should also be understood that while a D-SUB (D-subminiature) connector may be provided in the PLC modem 100, a D-SUB cable may be alternatively connected to this D-SUB connector.

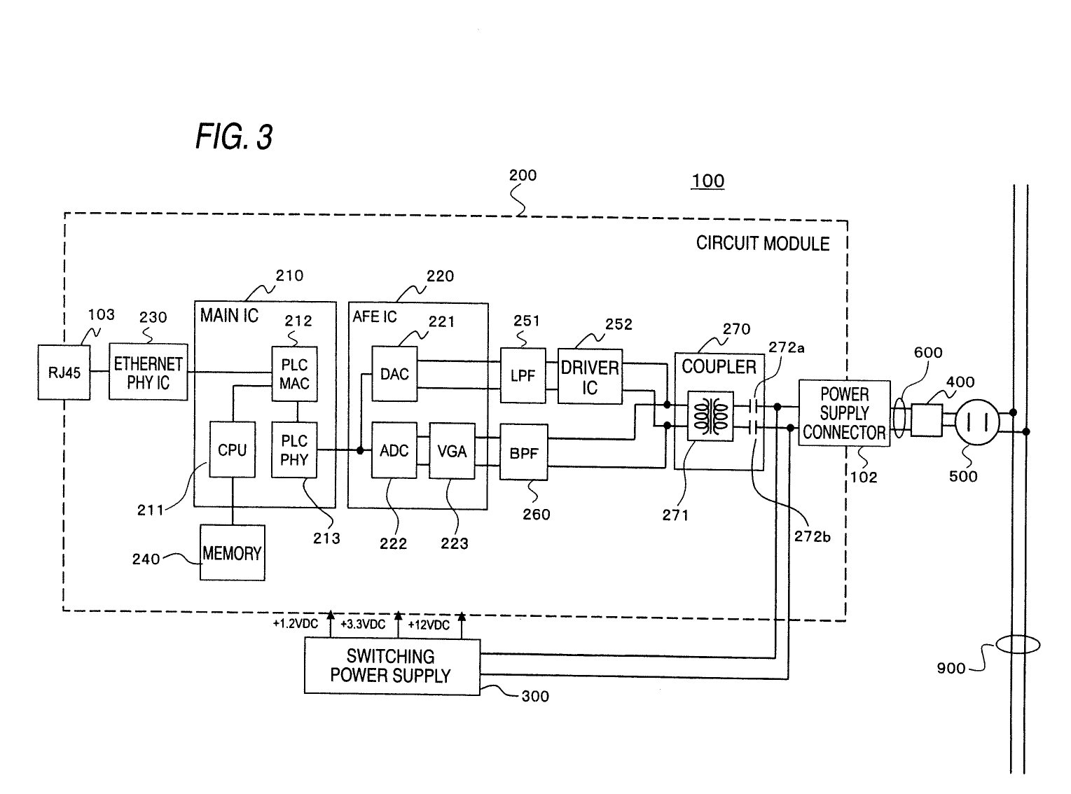

FIG. 3 indicates an arrangement of the PLC modem 100. In a circuit module 200, a PLC•IC (Integrated circuit) 210, an AFE•IC (Analog Front End IC) 220, a memory 240, a low-pass filter 251, a driver IC 252, and a band-pass filter 260 have been provided. The PLC•IC 210 is employed as a modulation/demodulation IC. Both a switching power supply 300 and a coupler 270 are connected to a power supply connector 102, and further, are connected via a power supply cable 600, a power supply plug 400, and an outlet 500 to the power line 900.

The PLC•IC 210 has been constituted by a CPU (Central Processing Unit) 211, a PLC•MAC (Power Line Communication Media Access Control layer) block 212, and a PLC•PHY (Power Line Communication Physical layer) block 213. The CPU 211 has mounted a 32-bit RISC (Reduced Instruction Set Computer) processor. The PLC•MAC block 212 manages MAC layers (Media Access Control layers) of transmission/reception signals, and the PLC•PHY block 213 manages PHY layers (Physical layers) of transmission/reception signals. The AFE•IC 220 has been arranged by a D/A converter (DAC) 221, an A/D converter (ADC) 222, and a variable gain amplifier (VGA) 223. The coupler 270 has been constituted by a coil transformer 271 and coupling-purpose capacitors 272a and 272b. It should also be understood that the CPU 211 controls operations of the PLC•MAC block 212 and the PLC•PHY block 213, and also, controls the entire operations of the PLC modem 100 by utilizing data stored in the memory 240.

The PLC modem 100 performs a multi-carrier communication by employing a plurality of sub-carriers of the OFDM (Orthogonal Frequency Division Multiplexing) system, and the like. The digital signal processes which performs such an OFDM signal transmission are especially carried out by the PLC•PHY block 213.

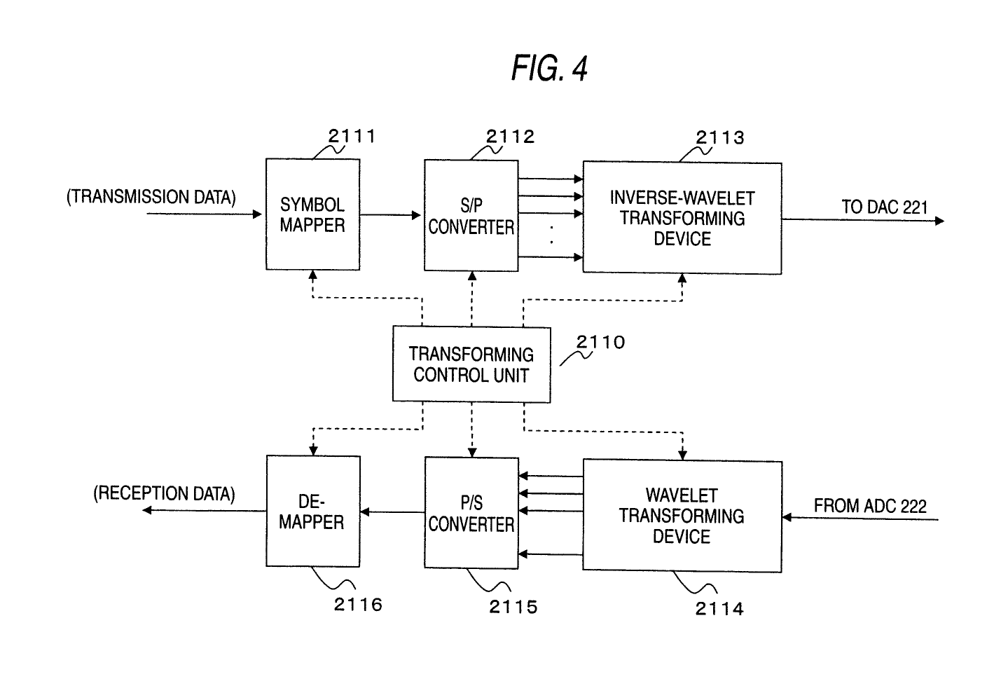

The digital signal processing unit of FIG. 4 is equipped with a transforming control unit 2110, a symbol mapper 2111, a serial-to-parallel converter (S/P converter) 2112, an inverse-wavelet transforming device 2113, a wavelet transforming device 2114, a parallel-to-serial converter (P/S converter) 2115, and a de-mapper 2116.

The symbol mapper 2111 converts bit data which should be transmitted into symbol data, and performs a symbol mapping operation (for example, PAM modulation) in accordance with the respective symbol data. The S/P converter 2112 converts serial data which have been mapped into parallel data. The inverse-wavelet transforming device 2113 performs an inverse-wavelet transforming operation with respect to the parallel data so as to obtain data on a time axis, namely generates a sample value series indicative of transmission symbols. This sample value series data is supplied to the D/A converter (DAC) 221 of the AFE•IC 220.

The wavelet transforming device 2114 performs a discrete wavelet transforming operation with respect to received digital data obtained from the A/D converter (ADC) 222 of the AFE•IC 220 onto a frequency axis. The above-described received digital data corresponds to such a sample value series which has been sampled in the same sampling rate as that when the digital data is transmitted. The de-mapper 2116 calculates amplitude values of the respective sub-carriers so as to judge a reception signal, and thus, acquires reception data.

A communication operation by the PLC modem 100 is roughly carried out as follows: That is, when data inputted from the RJ45 is received, a digital transmission signal produced by that the received data is supplied via the Ethernet PHY•IC 230 to the PLC•IC 210 and the supplied data is digitally processed is D/A-converted into an analog signal by the D/A converter (DAC) 221 of the AFE•IC 220, and then, the analog signal is outputted to the power line 900 via the low-pass filter 251, the driver IC 252, the coupler 270, the power supply connector 102, the power supply cable 600, the power supply plug 400, and also, the outlet 500.

When a signal is received from the power line 900, the received signal is supplied via the coupler 270 to the band-pass filter 260, and then, a gain of the supplied signal is controlled by the variable gain amplifier (VGA) 223 of the AFE•IC 220. Thereafter, the gain-controlled signal is A/D-converted by the A/D converter (ADC) 222 into a digital signal, and then, the digital signal is supplied to the PLC•IC 210 so as to be digitally processed, so that the inputted analog signal is converted into the digital signal. Then, this digital signal is outputted via the Ethernet PHY•IC 230 from the RJ45 connector 103.

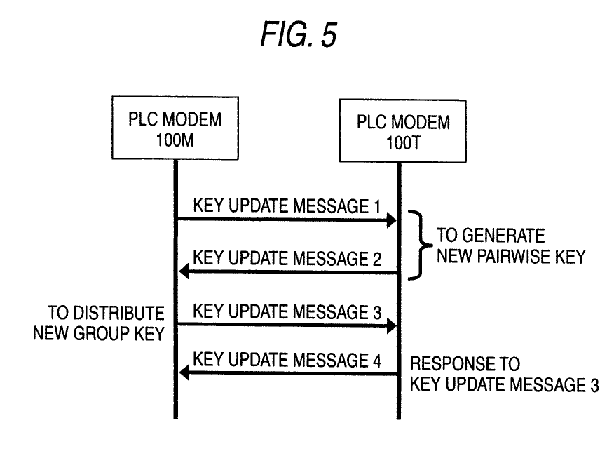

For the sake of simply explanations, in FIG. 5, a description is made of a handshake between the PLC modem 100M and a single PLC modem 100T. However, in an actual communication system, there is no problem that plural sets of the PLC modems 100T may be present. The below-mentioned process is related to an updating operation of the group key after the PLC modem 100T has been authenticated in an initial stage.

In the initial authentication, the PLC modem 100M and the PLC modem 100T transmit the own MAC addresses to each other in order to acquire MAC addresses of the communication counter party. Moreover, the PLC modem 100M and the PLC modem 100T calculate unicast keys while using the own MAC address and the MAC address of the communication counter party as a parameter.

A unicast key corresponds to one of keys which are shared by the PLC modem 100M and the PLC modem 100T, and this unicast key is utilized in order to encrypt information which is required to generate an pairwise key (will be discussed later), and also is employed so as to calculate an MIC (Message Integration Code) value. An MIC value is employed as a verification code capable of verifying an alteration of information.

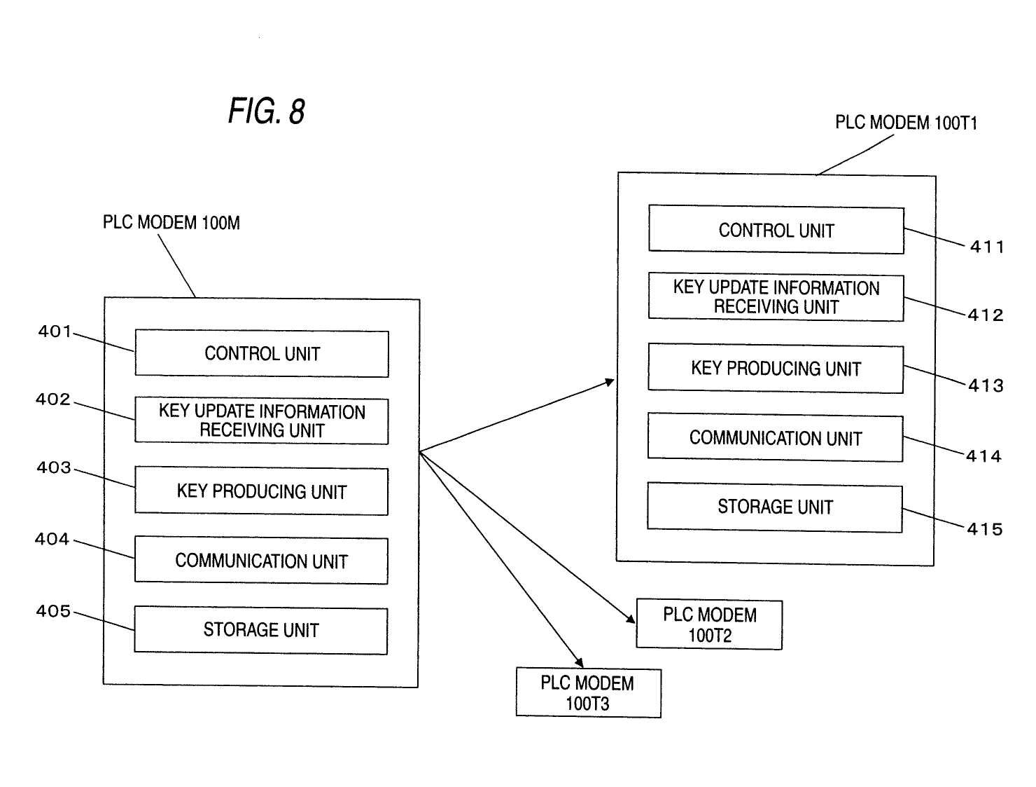

As to the PLC modem 100T whose initial verification has been performed, the PLC modem 100M registers a unicast key shared by this PLC modem 100T into a storage unit 405 (see FIG. 8). The unicast key registered in the storage unit 405 is utilized as identification information of the PLC modem 100T when the PLC modem 100M again authenticates the PLC modem 100T.

It should be noted that the PLC modem 100M may alternatively transmit a unicast key via a safety transmission line to the PLC modem 100T.

Also, a unicast key may be alternatively generated in such a manner that a user inputs the same passwords, or the same passphrases to both the PLC modem 100M and the PLC modem 100T via an electronic appliance such as a personal computer (will be referred to as “PC” hereinafter), and thus, may generate the unicast key by employing either the passwords or the passphrases.

Also, when a unicast key is distributed, the PLC modem 100M transmits nonce data generated by either the PLC modem 100M or an authentication server (not shown) with respect to the PLC modem 100T. At this time, both the PLC modem 100M and the PLC modem 100T generate a unicast temporary key based upon the unicast key and the nonce data.

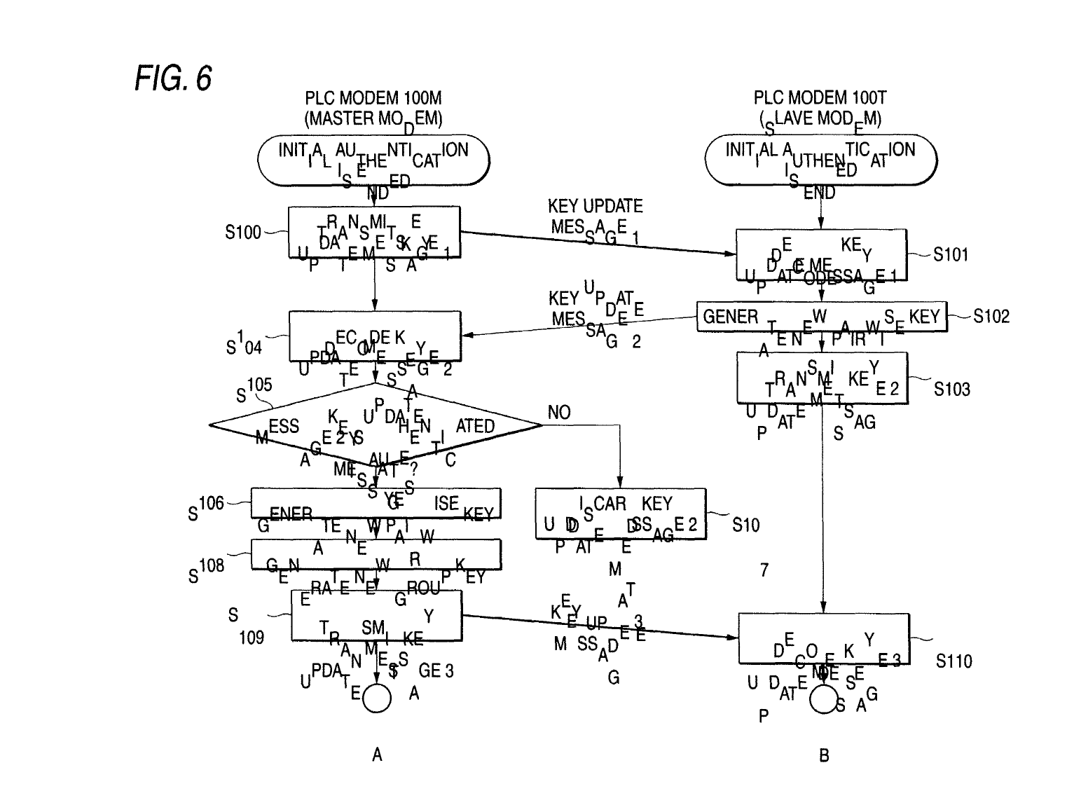

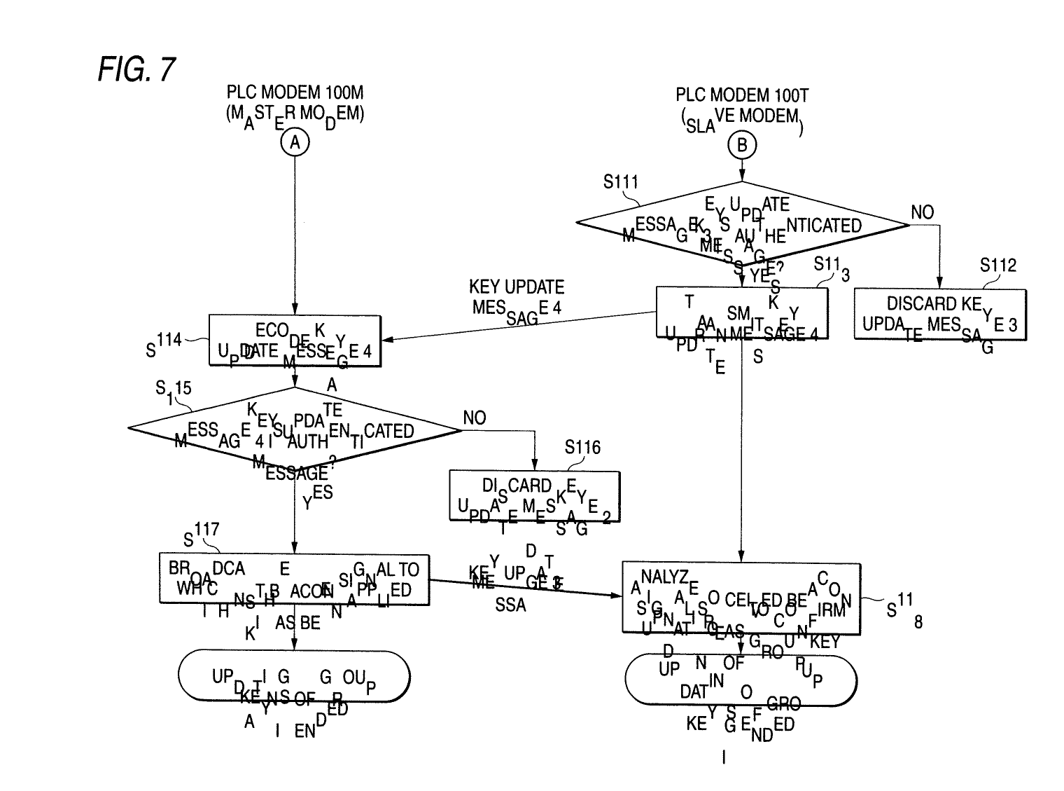

Referring now to FIG. 6 and FIG. 7, a description is made of the processes for updating the group key.

Firstly, the PLC modem 100M transmits a key update message 1 with respect to the PLC modem 100T (step S100). The key update message 1 is encrypted based upon a unicast key. The key update message 1 has contained thereinto information which is required in order to generate an pairwise key (will be discussed later), concretely speaking, this information of the key update message 1 is nonce data. The random nonce data is generated by the PLC modem 100T. It should be understood that the nonce data generated by the PLC modem 100M will be referred as “QNonce” hereinafter.

After the PLC modem 100T receives the key update message 1, the PLC modem 100T decodes the information which is required for generating the pairwise key by employing the unicast key (step S101). Also, the PLC modem 100T generates nonce data in a similar manner to that of the PLC modem 100M. It should also be noted that the nonce data generated by the PLC modem 100T will be referred to as “TNonce” hereinafter. The PLC modem 100T generates a new pairwise key by employing the MAC address of the PLC modem 100M acquired during the initial authentication, the own MAC address, the nonce data “TNonce”, and the unicast key (step S102). The pairwise key before the group key is updated (namely, previous pairwise key) is replaced by the above-described new pairwise key. The pairwise key generated between the PLC modem 100T and the PLC modem 100M is stored in the storage unit 405 of the PLC modem 100M.

Next, the PLC modem 100T transmits a key update message 2 to the PLC modem 100M as a response to the above-described key update message 1 (step S103). The key update message 2 has contained thereinto the TNonce, the QNonce, and an MIC value calculated by employing the previous pairwise key as to the key update message 1, which have been encrypted based upon the previous key.

Alternatively, when the first handshake is performed after the initial authentication of the PLC modem 100T has been carried out, the key which is employed in order to calculate and encrypt the MIC value of the key update message 2 may not employ the pairwise key, but may employ a unicast key, or a unicast temporary key which is generated from the unicast and the QNonce.

In such a case that after the PLC modem 100M has received the key update message 2 and has decoded the received key update message 2 based upon the previous pairwise key (step S104), the PLC modem 100M has authenticated the key date message 2 as an authenticated message, the PLC modem 100M generates a new pairwise key based upon the TNonce acquired by the decoding operation, the MAC address of the PLC modem 100T acquired during the initial authentication, the QNonce and the MAC address of the own PLC modem 100M, and also, the unicast key (step S106). A judgement whether or not the key update message 2 corresponds to the authenticated message (step S105) is performed by checking whether or not the decoded QNonce is made coincident with the QNonce generated by the own PLC modem 100M. When both the above-described nonce data QNonces are coincident with each other, the PLC modem 100T calculates an MIC value of information (TNonce etc.) other than the MIC value decoded by employing the pervious pairwise key, and then, confirms whether or not the calculated MIC value is made coincident with the decoded MIC value. When the calculated MIC value is not made coincident with the decoded MIC value, the PLC modem 100M discards the received message (step S107). When the calculated MIC value is made coincident with the decoded MIC value, the PLC modem 100M authenticates the received message as the authenticated message.

It should also be noted that in this exemplification, an algorithm for generating the new pairwise key by the PLC modem 100M is identical to an algorithm for generating the new pairwise key by the PLC modem 100T. At this stage, the PLC modem 100M and the PLC modem 100T share the new pairwise keys respectively.

It should also be understood that when the first handshake is performed after the initial authentication of the PLC modem 100T has been carried out, the unicast key, or the unicast temporary key is employed as an encryption key.

Next, the PLC modem 100M generates a new group key (step S108). Moreover, the PLC modem 100M transmits a key update message 3 with respect to the PLC modem 100T (step S109). The key update message 3 has contained thereinto the new group key, the QNonce, the TNonce, and the MIC value calculated by employing the new pairwise key as to the above-described information, which have been encrypted based upon the new pairwise key.

The PLC modem 100T which has received the key update message 3 decodes the information contained in the key update message 3 by employing the new pairwise key (step S110). Then, the PLC modem 100T confirms whether or not the TNonce obtained by the decoding operation is coincident with the TNonce generated by the own PLC modem 100T (step S111). When both the above-described nonce data TNonces are not coincident with each other, the PLC modem 100T discards the received key update message 3 (step S112). When both the above-described nonce data TNonces are coincident with each other, the PLC modem 100T confirms whether or not the QNonce obtained by the decoding operation is coincident with the QNonce received by the key update message 1. When both the above-described nonce data QNonces are not made coincident with each other, the PLC modem 100T discards the key update message 3. When both the above-described nonce data QNonces are coincident with each other, the PLC modem 100T calculates an MIC value as to such a message (for example, TNonce etc.) other than the MIC value obtained by the decoding operation by employing the new pairwise key, and then, confirms whether or not the calculated MIC value is made coincident with the decoded MIC value. When the calculated MIC value is not made coincident with the decoded MIC value, the PLC modem 100T discards the key update message 3. When the calculated MIC value is made coincident with the decoded MIC value, the PLC modem 100T authenticates the received key update message 3 as the authenticated message.

Next, the PLC modem 100T transmits a key update message 4 to the PLC modem 100M as a response with respect to the key update message 3 (step S113). The key update message 4 is encrypted based upon the new pairwise key. Also, the key update message 4 has contained thereinto an MIC value calculated by employing the new pairwise key with respect to this key update message 4.

The PLC modem 100M which has received the key update message 4 decodes the received key update message 4 (step S114). The PLC modem 100M calculates an MIC value employing the new pairwise key with respect to such a message other than the MIC value obtained by the decoding operation, and then, confirms whether or not the calculated MIC value is made coincident with the MIC value obtained by the decoding operation (step S115). When the calculated MIC value is not made coincident with the decoded MIC value, the PLC modem 100M discards the key update message 4 (step S116). When the calculated MIC value is made coincident with the decoded MIC value, the PLC modem 100M authenticates the received key update message as the authenticated message.

The PLC modem 100M which has authenticated the key update message 4 as the authenticated message applies update information “NKI (Network Key Index)” of the group key to a beacon signal broadcasted from the PLC modem 100M, and thereafter, broadcasts the resulting beacon signal (step S117). Since the PLC modem 100T receives the beacon signal so as to analyze the update information of the group key, the PLC modem 100M confirms that the group key has been updated (step S118). The above-explained process implies the process for updating the group key. A communication after the group key has been updated is encrypted by employing the new group key. The updating operation of the group key is carried out every time a predetermined time period has elapsed (for example, being performed on time per 1 hour) has elapsed.

It should also be noted that the encryption based upon the unicast key is carried out with respect only to information such as key information which is changed in the irregular manner.

Also, such a message is not distributed which has been encrypted based upon a unicast key which has not yet been registered in the storage unit 405 of the PLC modem 100M. As a consequence, a previous unicast key is updated as a new unicast key when a group key is updated, so that such a message which has been encrypted by employing the previous unicast key is not distributed. Also, when the PLC modem 100T is left from a communication network, such an pairwise key which corresponds to this PLC modem 100T is discarded from the storage unit 405 of the PLC modem 100M, so that this discarded pairwise key becomes invalid.

A major circuit portion as to the circuit for performing the group key updating process, which is shown in FIG. 8, has been contained in the main IC 210 shown in FIG. 3. As to this point, a description is made of the PLC modem 100M as an example. A control unit 401 is contained in the CPU 211. A key information receiving unit 402 and a communication unit 404 are contained in the PLC•MAC block 212. A key producing unit 403 is contained in the CPU 211 and the PLC•MAC block 212.

Functions of the respective blocks will be described as follows: That is, the control unit 401 executes control operations with respect to the respective blocks for performing the key updating process; the control unit 401 encrypts and decrypts key update messages; and the control unit 401 executes an authentication process for authenticating the key update messages. The key information receiving unit 402 receives a key update message. The key producing unit 403 generates various sorts of encryption keys by employing information (namely, MAC address, nonce data etc.) contained in the key update message by the control unit 401. The communication unit 404 transmits the key update message. The storage unit 405 registers thereinto an authenticated unicast key of the PLC modem 100T.

Since functions of the PLC modem 100T are overlapped with the functions of the PLC modem 100M, a description thereof will be omitted.

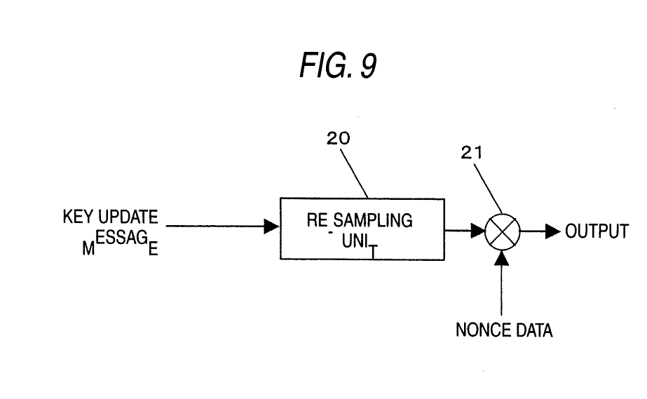

FIG. 9 represents a coding process block for encrypting a key update message. It is so assumed that the encrypting operation of the key update message is carried out by the PLC modem 100M. This coding process block is contained in the above-described control unit 401.

In FIG. 9, a re-sampling unit 20 expands a bit time period of a key update message. The re-sampling unit 20 expands the bit time period of the key update message until this expanded bit time period becomes the same time period as that of nonce data which is employed in a coding operation. The nonce data is employed as such an information which is used so as to code the key update message, and is generated by the control unit 401. In order to generate the nonce data, a quasi-random number function is employed.

The re-sampling unit 20 processes the key update message based upon a FIFO (First-In First-Out) system. At this time, the re-sampling unit 20 expands the bit time period of the key update message by making a difference between a sampling time period (namely, writing speed to queue) of the key update message when the key update message is inputted to a queue (not shown) and a sampling time of the key update message when the key update message is outputted from the queue.

The key update message whose time period has been expanded in the re-sampling unit 20 is inputted to a multiplying unit 21. The multiplying unit 21 multiplies the key update message whose time period has been expanded by the nonce data, and then, outputs a product between them. The control unit 401 generates nonce data by employing the quasi-random function. The nonce data are different from each other, depending upon the respective PLC modems 100T which are authenticated by the PLC modem 100M. Also, the nonce data are determined in such a manner that products between the key update messages outputted by the multiplying unit 21 and the nonce data are different from each other every 1 bit. Since the nonce data are different from each other every 1 bit, it is possible that an adverse influence caused by a DoS attack by a third party can be reduced, and an illegal acquisition of a key update message by a third party can be reduced. As a result, the key update message can be transmitted in a safer manner.

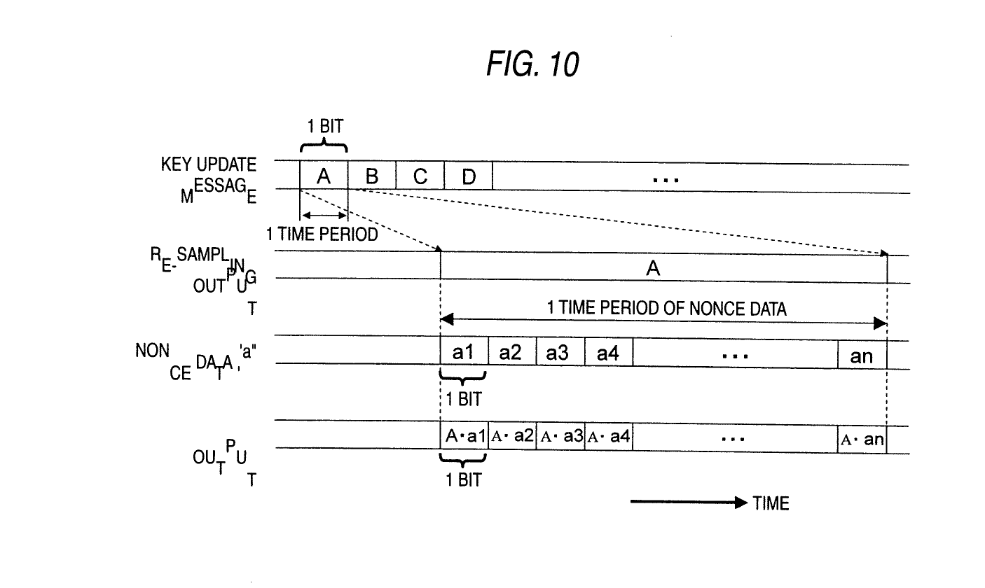

As shown in FIG. 10, the coding process is carried out in the unit of a bit.

In FIG. 10, bits “A”, “B”, “C”, “D”, . . . , which constitute a bit stream of a key update message, contain a 1-bit information amount, respectively.

Also, FIG. 10 shows a bit “A”, the time period of which has been expanded by the re-sampling unit 21. The expanding operations of time periods by the re-sampling unit 20 are carried out with respect to other bits than the bit “A.” The re-sampling unit 20 expands the time period of the bit “A” in such a manner that the expanded time period of this bit “A” becomes equal to a time period of nonce data “a” (will be discussed later). As apparent from FIG. 10, a transmission information amount of the nonce data “a” per unit time is equal to a transmission information amount of the key update message per unit time.

Further, FIG. 10 represents the above-described nonce data “a.” The nonce data “a” has an n-bit information amount, and is generated by employing a unicast key when a first key updating operation is carried out after an initial setting operation has been performed. Also, the nonce data “a” is generated based upon both the above-described nonce data QNonce and TNonce when a key updating operation is performed after the first key updating operation has been carried out.

Further, FIG. 10 represents a product between the nonce data “a” and the bit “A” whose time period has been expanded and which is outputted from the multiplying unit 21. It should be also understood that the nonce data “a” is also multiplied by any other bits than the bit “A.”

A key update message is outputted with respect to a PLC modem of a communication counter party as a product between a bit stream of the key update message and nonce data.

Assuming now that an output signal from the re-sampling unit 20 with respect to a bit “A” (either “+1” or “−1”) of a key update message is defined as “RS” (either “+1” or “−1”), and a nonce which is multiplied by the above-described output signal “RS” is defined as “ai” (either “+1” or “−1”: i=1 to N), an output signal “Si” may be expressed by the below-mentioned (formula 1), while the output signal “Si” implies a product between a bit stream of a key update message and nonce data.

Si=RS×ai [Formula 1]

A different point as to the coding system represented in FIG. 9 and FIG. 10 with respect to the conventional spread spectrum communication system is given as follows: That is, a time period of a key update message is expanded every bit in such a manner that the expanded time period of this key update message becomes equal to a time period of nonce data.

As also apparent from FIG. 10, it is possible to understood that a transmission information amount per unit time as to a product between the expanded key update message and the nonce data is equal to a transmission information amount per unit time as to the key update message.

As a consequence, with respect to the product between the expanded key update message and the nonce data, similar to the coded output of the spread spectrum communication system, there is no possibility that the information amount per unit time is not increased. Accordingly, there is no possibility that a frequency bandwidth contained by the product between the expanded key update message and the nonce data is not increased.

In the coding system represented in FIG. 9 and FIG. 10, the key update messages can be distributed without increasing the frequency band. As a result, this coding system may be suitably applied to such a communication system as a power line communication that a usable frequency band thereof is limited.

Alternatively, it should also be noted that when the first key updating operation is carried out after the initial setting operation of the PLC modem 100M and the PLC modem 100T shown in FIG. 5 has been performed, the coding operation of the key update message 1 may be carried out by employing the nonce data which is generated by using the unicast key as a parameter; the coding operation of the key update message 2 may be carried out by employing the nonce data which is generated by using both the unicast key and the nonce data QNonce as a parameter; and further, the coding operations of the key update messages 3 and 4 may be carried out by employing the nonce data which is generated by using the above-described nonce data QNonce and TNonce as a parameter.

Alternatively, the nonce data may be generated based upon the unicast key, QNonce, TNonce, and also, information related to the order of the output bits from the re-sampling unit 20. If the nonce data are generated in the above-described manner, then a random characteristic may be applied to the nonce data, so that security with respect to the encryption may be increased.

The above-described nonce data are continuously generated from such a secret information which is not known by a third party. As a consequence, even in such a case that the communication terminal of the third party has received a key update message transmitted from the PLC modem 100M, the communication terminal of the third party cannot decode the received key update message, so that security of the communication can be improved.

Also, even in such a case that the communication terminal of the third party has received a key update message transmitted from the PLC modem 100M, and then, has transmitted a response message with respect to the received key update message, since both the communication terminal of the third party and the PLC modem 100M have no such a shared encryption key, the PLC modem 100M cannot decode this response message. As a consequence, security of the communication can be improved.

Also, it is suitable that a length of nonce data is made equal to a length of an output bit of the re-sampling unit 20. If the length of the nonce data is made equal to the length of the output bit, then the nonce data may be simply generated.

It is also preferable to employ an orthogonal code may be employed as the nonce data with respect to information except for the above-described nonce data QNonce, TNOnce, and the group key. If the orthogonal code is employed, then timing of an output bit may be easily extracted. As the orthogonal code, an M series, a cyclic shift M series, and the like may be conceived.

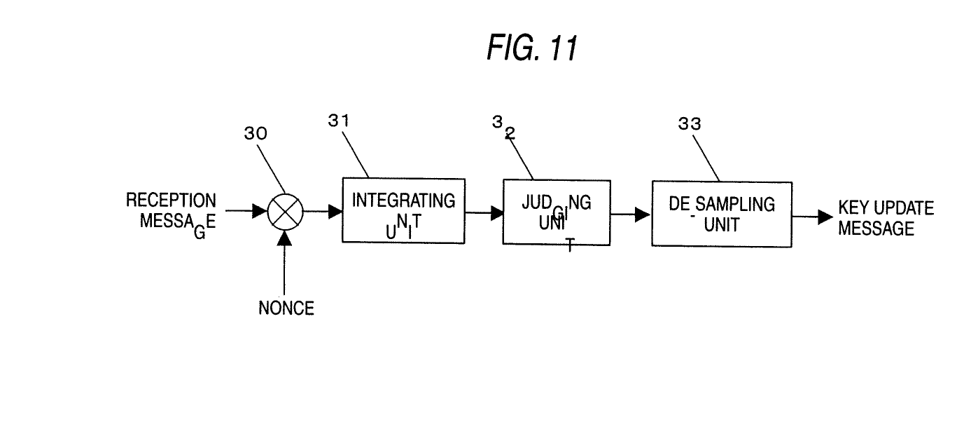

FIG. 11 shows a coding process block for decoding a key update message. It is so assumed that the decoding operation of the key update message is carried out by the PLC modem 100T. The coding process block shown in FIG. 11 is involved in the control unit 411.

In FIG. 11, a multiplying unit 30 performs a multiplication of a received message by employing nonce data and then outputs a multiplication result. In this case, the received message corresponds to the product calculated between the key update message and the nonce data, which is represented in FIG. 10. The nonce data is employed as such an information for decoding the received message, and is generated by the control unit 411. In order to generate the nonce data, a quasi-random number function is employed. An integrating unit integrates an output signal from the multiplying unit 30, and then outputs the integrated output signal. A judging unit 32 judges a polarity as to an output signal from the integrating unit 31, and then, outputs a judgement result. In other words, the judging unit 32 judges whether the output signal from the integrating unit 31 is a positive value, or a negative value. A de-sampling unit 33 compresses a time period of the output signal from the judging unit 32. Similar to the re-sampling unit 20, the de-sampling unit 33 performs a compressing process of a time period based upon the FIFO (First-In First-Out) system.

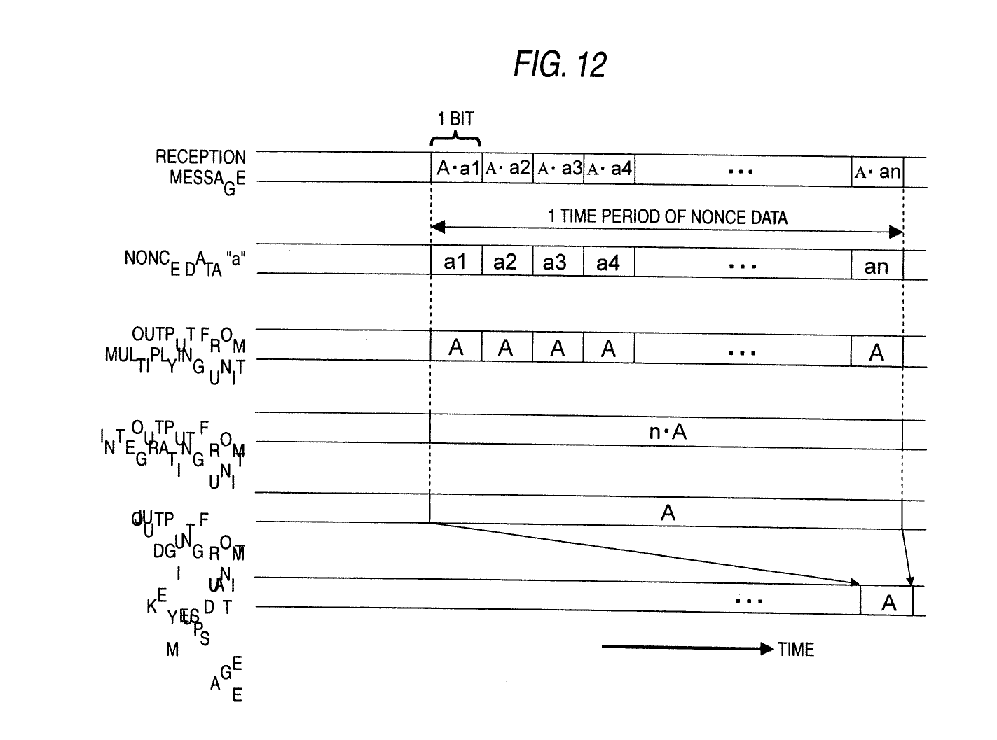

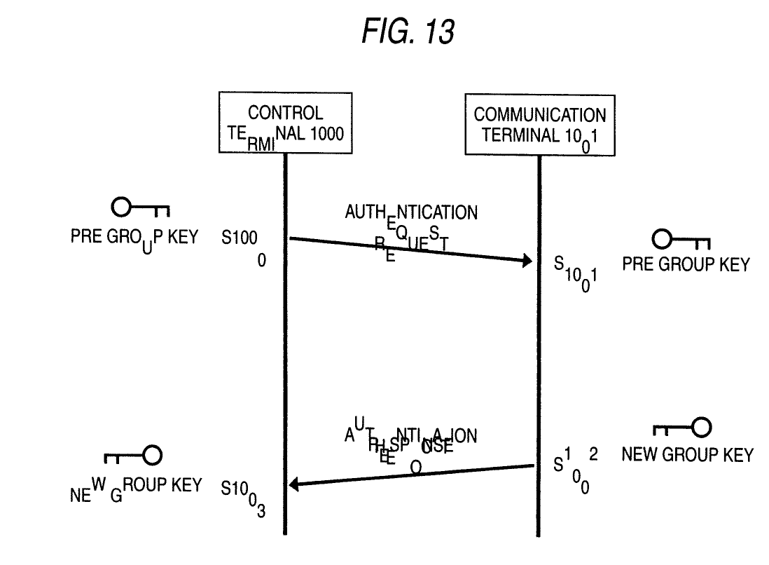

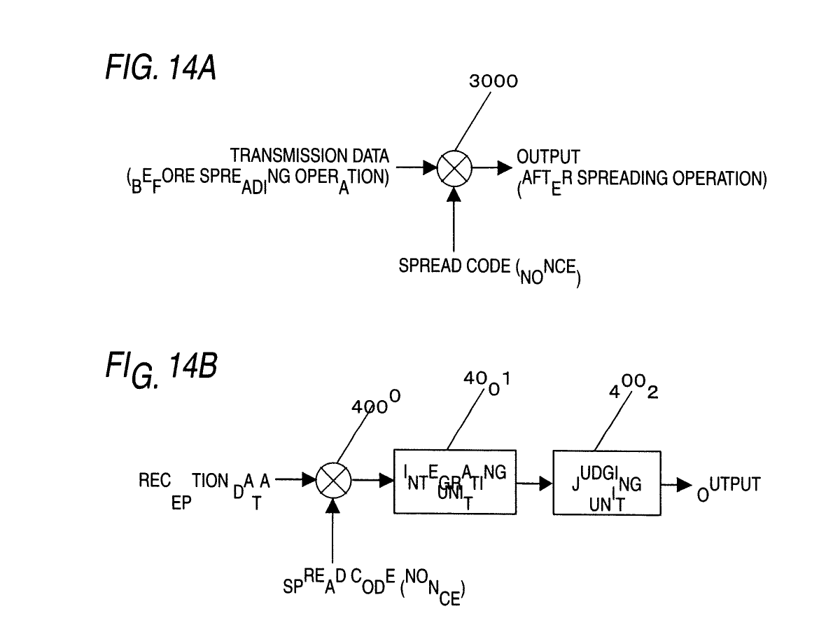

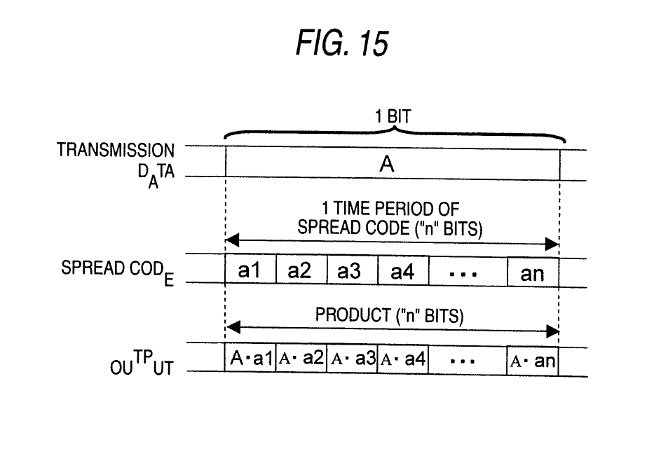

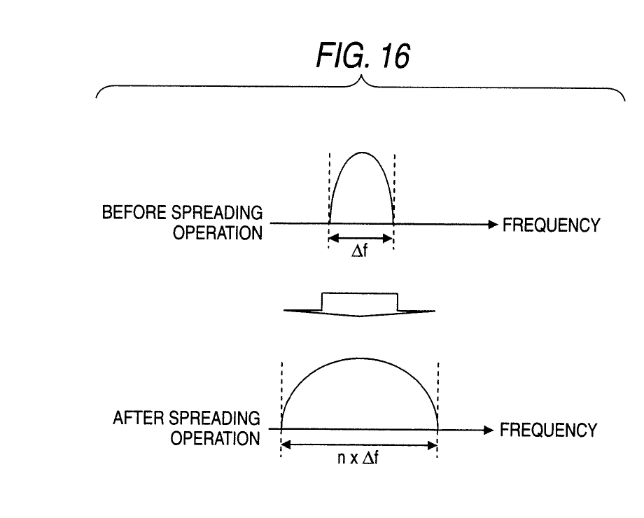

As shown in FIG. 12, the coding process is carried out in the unit of a bit.

FIG. 12 shows a bit stream of a received message. Each of bits “A•a”, “A•a2”, “A•a3.”, “A•a4”, which constitute the above-described bit stream contains a 1-bit information amount.

Generally speaking, noises appeared on a transmission line, and signals supplied from a third party (attacker) are added to the received messages.

Assuming now that the noises of the transmission line are defined as “Ni” (i=1 to N) and the signals supplied from the third party are defined as “Sij” (i=1 to N, j=1 to L, and “i” is not equal to “j”), the received message “Ri” (i=1 to N) is expressed by the below-mentioned (formula 2):

$$Ri = Si + Ni + {\sum }_{j = 1}^{L} Sij \qquad [ Formula 2 ]$$

Also, FIG. 12 shows nonce data “a.” The nonce data “a” contains an n-bit information amount, and is identical to the nonce data “a” employed when the encrypting operation is carried out in the PLC modem 100M.

Further, FIG. 12 represents a product between the nonce data “a” and the received message “Ri” outputted from the multiplying unit 30. A multiplication with respect to the nonce data “a” is performed with respect also to bits other than the bit “A.” The product between the received message “Ri” and the nonce data “a” becomes “n” pieces of the bit “A”, whose information amount becomes “n” bits.

Further, FIG. 12 shows an output signal from the integrating circuit 31. This output signal of the integrating unit 31 has a value of “n·A”, and an information amount of this output signal becomes “log₂ n.” An output signal “IS” of the integrating unit 31 is expressed by the below-mentioned (formula 3):

$$\begin{matrix}IS = {\sum }_{i = 1}^{N} Ri \times ai \\ = {\sum }_{i = 1}^{N} ( Si + Ni + {\sum }_{j = 1}^{L} Sij ) \times ai \\ = ( {\sum }_{i = 1}^{N} ( Si \times ai ) + ( {\sum }_{i = 1}^{N} Ni \times ai ) + RSj \times {\sum }_{i = 1}^{N} {\sum }_{j = 1}^{L} aij \times ai ) \\ = RS \times N + ( {\sum }_{i = 1}^{N} Ni \times ai ) + RSj \times ( {\sum }_{i = 1}^{N} {\sum }_{j = 1}^{L} aij \times ai )\end{matrix} \qquad [ Formula 3 ]$$

In this formula (3), symbols “RSj” and “aij” are an output signal from the re-sampling unit 20 and a nonce respectively, which correspond to the signal “Sij” of the third party. It is so assumed that a sequence “aij” (i=1 to N) of a nonce is different from another sequence “ai” of a nonce with respect to an arbitrary “j.” A first term of the lowermost stage of the above-described formula 3 indicates a signal component of the received message; a second term thereof shows a noise component on the transmission line; and a third term thereof represents a component of such a signal which is not intended to be transmitted from the third party (attacker).

Further, FIG. 12 indicates an output signal from the judging unit 32. A time period of this output signal from the judging unit 32 is equal to the time period of the nonce data “a”, and an information amount thereof is 1 bit.

The judging unit 32 analyzes whether an output signal from the integrating unit 31, which is expressed by the above-described formula 3, corresponds to a positive value, or a negative value (namely, polarity) so as to output “+1” when the positive value is outputted, and to output “−1” when the negative value is outputted.

In this case, a second term of the lowermost stage formula within the above-described formula 3 will now be considered. This second term expresses a noise component on a transmission line. Normally, under such an environment that the transmission line is deteriorated, an error rate caused by the noise becomes approximately 0.01. For instance, assuming now that “N” is 128, the value of the second term becomes approximately 1. As a consequence, the noise component of the received message becomes sufficiently small, as compared with the signal component thereof.

Further, FIG. 12 indicates an output signal from the de-sampling unit 33. In the de-sampling unit 33, a compressing process of a time period is carried out, so that the decoding process of the key update message is accomplished.

Next, a third term of the lowermost formula within the above-described formula 3 will be considered. This third term represents a component of such a signal which is not intended to be transmitted from a third party (attacker).

As to a formula expressed in a grouping symbol of the third term, in the case that “N” is sufficiently large, this formula may be approximated by such a normal distribution that an averaged value is equal to 0, and a standard deviation is √(L×N×0.5). For instance, assuming now that RSj=1, N=128, and L=16, if timing as to the signal component of the received message is completely identical to timing as to the component of the signal which is not intended to be transmitted from the third party (attacker), then probability with respect to erroneous judgements made by the judging unit 32, namely, such a probability that the third term becomes larger than the first term may become approximately 0.003%. As a consequence, it is conceivable that the probability at which the judging unit 32 may cause the erroneous judgements due to the DoS attacks and the like is sufficiently small.

Accordingly, it is possible to avoid that the transmission efficiency is lowered, which is caused by the erroneous transmissions of the key update messages, the DoS attacks, and so on.

As a consequence, in accordance with the above-described communication apparatus and method of the present embodiment, even in a communication system using a deteriorated transmission line such as a power line communication, a total number of re-transmissions of key distributions can be considerably reduced, and further, the resistibility with respect to the DoS attacks and the like can be established.

### INDUSTRIAL APPLICABILITY

Since the key update information can be transmitted without increasing the frequency band, the present invention can be suitably applied to such a communication system that the usable frequency band has been limited, for instance, power line communications.

Also, since the communication method and apparatus according to the present invention can have the resistibility with respect to the illegal accesses and the DoS attacks, the present invention can suppress that the key update information is acquired by the third party in the illegal manner, and the transmission efficiency is lowered due to the DoS attacks.

It should also be understood that the present invention may be alternatively applied to wireless communications, and the like.

This application is based upon and claims the benefit of priority of Japanese Patent Applications No. 2007-144796 filed on May 31, 2007 and 2008-116826 filed on Apr. 28, 2008, the contents of which are incorporated herein by reference in their entirety.

What is claimed is:

1. A communication apparatus for transmitting key update information via a transmission line to another communication apparatus, comprising:
a key update information generating section that generates the key update information having a first time width;
a code information generating section that generates code information which is employed to code the key update information;
a time width expanding section that expands the first time width to a second time width; and
a coding process section that performs a coding process with respect to key update information having the second time width by employing the code information.

2. The communication apparatus according to claim 1, further comprising:
a transmitting section that transmits the key update information coded by the coding process section to the another communication apparatus.

3. The communication apparatus according to claim 1, wherein the code information has a third time width; and
wherein the third time width is equal to the second time width.

4. The communication apparatus according to claim 1, wherein the coding process section multiplies the key update information by the code information as the coding process.

5. The communication apparatus according to claim 4, wherein a product between the code information and the key update information having the second time width has the same time width as the second time width.

6. The communication apparatus according to claim 1, wherein the code information is an orthogonal code.

7. The communication apparatus according to claim 6, wherein the orthogonal code is an M series.

8. The communication apparatus according to claim 6, wherein the orthogonal code is a cyclic shift M series.

9. The communication apparatus according to claim 1, wherein the key update information has first data and second data;
wherein the code information generating section generates both first code information corresponding to the first data, and second code information which corresponds to the second data and is different from the first code information; and
wherein the coding process section performs a coding process of the first data by employing the first code information, and performs a coding process of the second data by employing the second code information.

10. The communication apparatus according to claim 9 wherein each of the first data and the second data has a predetermined-bit information amount.

11. The communication apparatus according to claim 10, wherein each of the first data and the second data has a 1-bit information amount.

12. The communication apparatus according to claim 1, wherein the transmission line is a power line.

13. The another communication apparatus as set forth in claim 1, comprising:
a receiving section that receives the coded key update information transmitted from the communication apparatus via the transmission line;
a decode information generating section that generates decode information for decoding the coded key update information;
a decoding process section that performs a decoding process of the coded key update information by employing the decode information to acquire key update information having the second time width; and
a time width compressing section that compresses the second time width.

14. The another communication apparatus according to claim 13, wherein the time width compressing section compresses the second time width until the compressed second time width becomes equal to a first time width.

15. The another communication apparatus according to claim 13, wherein the decoding process section multiplies the decode information by the coded key update information as the decoding process.

16. An integrated circuit which is employed in a communication apparatus for transmitting key update information via a transmission line to another communication apparatus, comprising:
a key update information generating section that generates the key update information having a first time width;
a code information generating section that generates code information which is employed to code the key update information;
a time width expanding section that expands the first time width to a second time width; and
a coding process section that performs a coding process with respect to key update information having the second time width by employing the code information.

17. A communication method for transmitting key update information via a transmission line to another communication, comprising:
generating the key update information having a first time width;
generating code information which is employed to code the key update information;
expanding the first time width to a second time width; and
performing a coding process with respect to key update information having the second time width by employing the code information.
